(19) United States
(12) Patent Application Publication
(10) Pub. No.: US 2011/0099500 A1
(43) Pub. Date: Apr. 28, 2011

(54) HISTORICAL NETWORK EVENT VIEWING

(76) Inventors: Jared Smith, Round Rock, TX (US); Gurminder Singh, Union City, CA (US); Sandra Lo, Sunnyvale, CA (US); Hari Shankar, San Jose, CA (US)

(21) Appl. No.: 12/606,966

(22) Filed: Oct. 27, 2009

(51) Int. Cl. G06F 3/048

(52) U.S. Cl. 715/771

(57) ABSTRACT

A computer-implemented method, comprising determining a displayable sub range of events from among event records in a stored repository of network event data; determining a start time; in response to determining the start time, loading from the repository, a subset of a specified number of event records representing only network events that occurred at one or more network infrastructure elements before the start time; graphically displaying, in a first portion of a screen display on a display unit, an event graph that plots a number of network events that occurred in each of a plurality of discrete time periods represented by the sub range of events, and between the start time and the end time; graphically displaying, over the event graph, a time slider and a loaded event indicator area that is delimited by the start time and the end time; displaying, in a second portion of the screen display, a table listing only such network events as occurred between the start time and end time as indicated by the loaded event indicator area; wherein the steps are performed by one or more computing devices.

### TECHNICAL FIELD

The present disclosure generally relates to computer network management. The disclosure relates more specifically to viewing information about events, traps, error messages and other notifications emitted by network devices such as routers, switches, firewalls, intrusion detection sensors and intrusion prevention sensors.

### BACKGROUND

The approaches described in this section could be pursued, but are not necessarily approaches that have been previously conceived or pursued. Therefore, unless otherwise indicated herein, the approaches described in this section are not prior art to the claims in this application and are not admitted to be prior art by inclusion in this section.

Computer networks, such as the internet, an intranet, or a wireless or Ethernet network, transmit data from one processor to another. Network processors such as routers or switches generate error messages, traps, notifications, and other forms of event messages relating to transmissions. Recovering after an error or understanding what caused an error to minimize future errors is often complicated, in part because it is difficult to ascertain exactly what the network, or the part of the network that failed, was doing immediately before the error occurred. For example, it may be difficult to isolate a particular time at which a cluster of related events occurred, and to correlate the cluster with particular devices.

Although network event logging and viewing tools are available, network event viewing is difficult to manage because of the large volumes of event data that are displayed. Administrators find it difficult to focus on the particular event information that is relevant to a particular problem or related to a particular issue of interest.

### BRIEF DESCRIPTION OF THE DRAWINGS

In the drawings:

FIG. 1 illustrates a user interface display.

FIG. 2 illustrates a processor configured to provide a visual display of network events.

FIG. 3 illustrates providing a visual display of network events.

FIG. 4 further illustrates providing the visual display of network events.

FIG. 4 illustrates an example graphical user interface.

FIG. 5 illustrates example programmatic objects and relationships that may be used in an embodiment.

FIG. 6 illustrates an example computer system of an embodiment.

FIG. 7 illustrates a computer with which an embodiment may be used.

### DETAILED DESCRIPTION

Historical network event viewing is described. In the following description, for the purposes of explanation, numerous specific details are set forth in order to provide a thorough understanding of the present invention. It will be apparent, however, to one skilled in the art, that the present invention may be practiced without these specific details. In other instances, well-known structures and devices are shown in block diagram form in order to avoid unnecessarily obscuring the present invention.

Embodiments are described herein according to the following outline:
1.0 General Overview
2.0 Structural and Functional Overview
   2.1 Example User Interface
   2.2 Computer System Example
   2.3 Method of Event Viewing
3.0 Historical Network Event Viewing—Detailed Example
   3.1 View Management
   3.2 Event Table
      3.2.1 Historical Event Viewing
      3.2.2 Real Time Event Viewing
      3.2.3 Event Column Display
   3.3 Event Details
   3.4 Example System Architecture and Data Structures
4.0 Implementation Mechanisms—Hardware Overview
5.0 Extensions and Alternatives

1.0 General Overview

In an embodiment, a computer-implemented method comprises determining a displayable sub range of events from among event records in a stored repository of network event data; determining a start time; in response to determining the start time, loading from the repository, a subset of a specified number of event records representing only network events that occurred at one or more network infrastructure elements before the start time; graphically displaying, in a first portion of a screen display on a display unit, an event graph that plots a number of network events that occurred in each of a plurality of discrete time periods represented by the sub range of events, and between the start time and an end time; graphically displaying, over the event graph, a time slider and a loaded event indicator area that is delimited by the start time and the end time; displaying, in a second portion of the screen display, a table listing only such network events as occurred between the start time and end time as indicated by the loaded event indicator area; wherein the steps are performed by one or more computing devices.

Various other embodiments provide an apparatus configured to perform the preceding steps and a computer-readable storage medium storing instructions which when executed result in performing the steps.

2.0 Structural and Functional Overview

Historical network event viewing is described. In an embodiment, a network management computer is configured to load, from a stored repository of network event data, only a fixed set of data from among a larger set of records that satisfy a query to a database or a view of the database. Consequently, by loading only chunks of all available data, on the order of 50,000 events, for example, the network management computer may be configured with a reasonable amount of main memory. The amount of data that is loaded may vary in different implementations, for example, depending on the amount of memory available in a client computer.

A time slider provides a graphical mechanism to specify a starting point for event data to be loaded; in an embodiment, the time slider is graphically displayed using an icon. A set of records to be loaded is determined, in one embodiment, as a specified number of records in the database that are earlier in time than a position indicated by the time slider. Thus, in one implementation the database might hold 500,000 event records; a query or view might be satisfied by the most recent 200,000 records occurring between time T1 and time T2; a user might position the time slider at time T2; and in response the system might load the 50,000 event records at time T2 and immediately preceding time T2.

A time range represented in the records that are loaded may be graphically displayed in a shaded color such that the shaded region corresponds to the portion of events within the query results that are currently loaded and available for viewing. Concurrently, a screen display of the display unit shows an event density graph, and the time slider is displayed over the graph. A user can graphically manipulate the time slider, for example, to rapidly jump to a spike in the number of events. As a result, a user can rapidly focus the display of an event listing or event details upon only those events of interest.

In an embodiment, the graphical display provides links to functions to query, view, sort, or group the events that are currently loaded into the event viewer. Unlike past approaches, sorting and grouping becomes practical through the lazy loading of only a subset of data associated with the event density graph or the time slider. For example, in one embodiment a specified number of records configured to load into client computer memory is loaded starting from a point indicated by the time slider. The lazy approach of data loading, in combination with loading data in response to movement of the time slider and only loading events associated with a specified number of records earlier than the time point indicated by the time slider, provides the benefit of loading only data that is needed to populate an associated event table. As a result, the computational burden involved in processing a user query for event data is greatly reduced.

The approaches herein can be applied to records of normal network events, network security events, time sequenced log data relating to flows of traffic, status messages, syslog data, notifications, and other packet, flow, logs maintained for audit purposes, or other log records.

In one embodiment, a user selects a range of time in which network events may have occurred or are known to have occurred. The range may be defined by specifying an overall time window for a query or view that returns a set of event records. The user may then select a start time and an end time for a subset of records within the overall time window. Selecting a start time for the subset may be accomplished by the user moving a time slider positioned on an event graph or somewhere else on the screen; then the system automatically determines the end time after loading a specified number of records for events occurring at and earlier than the start time. Thus the end time may be earlier than the start time. For example, the user might move the time slider to 06:00:00; the system might then load 50,000 records preceding that time so that the end time is 05:40:00. Alternatively, the user may type a start time and end time into a text box or select time values from a plurality of choices. The set of records that is loaded may be indicated graphically in the event graph as a loaded event indicator area, which may be shaded or displayed in color.

In response, data representing network events taking place before the start time is loaded or obtained. For example, a mass storage device may maintain a repository of a large number of data records relating to network events, e.g., millions of events; however, a particular time window might involve loading only a few tens of thousands of events.

Data representing network events may be stored locally in mass storage of a network management computer or on a network device. The network event data may be loaded before a user selects the start time; for example, a default time window may be used and the system may load network event data for events occurring or emitted by network devices at times that fall within the default time window.

In an embodiment, a portion of a screen display on a display unit displays an event graph comprising a graphical line that indicates a number of network events in each of a plurality of discrete time periods between the start time and the end time. Preferably, the number of events is indicated in events per second (EPS).

In an embodiment, a second portion of the screen display comprises an event table, listing network events that occurred between the start time and the end time. If the number of network events between the start time and the end time is less than a configured maximum number of events to load, then all events covered by a loaded event indicator area are shown in the event table. In an embodiment, a user can select an event from the event table; in response, the computer displays detailed information about the event in an event details region of the screen display.

In an embodiment, a user can sort the events in the event table based on a plurality of sorting criteria. For example, the events may be sorted by time, event type, duration, amount of data impacted, etc.

In another embodiment, a portion of the screen display provides a data filter panel. A user may select one or more filter criteria, and all events not meeting the filter criteria are removed from the event table. Other embodiments may provide a toolbar or a view navigation bar in the screen display.

2.1 Example User Interface

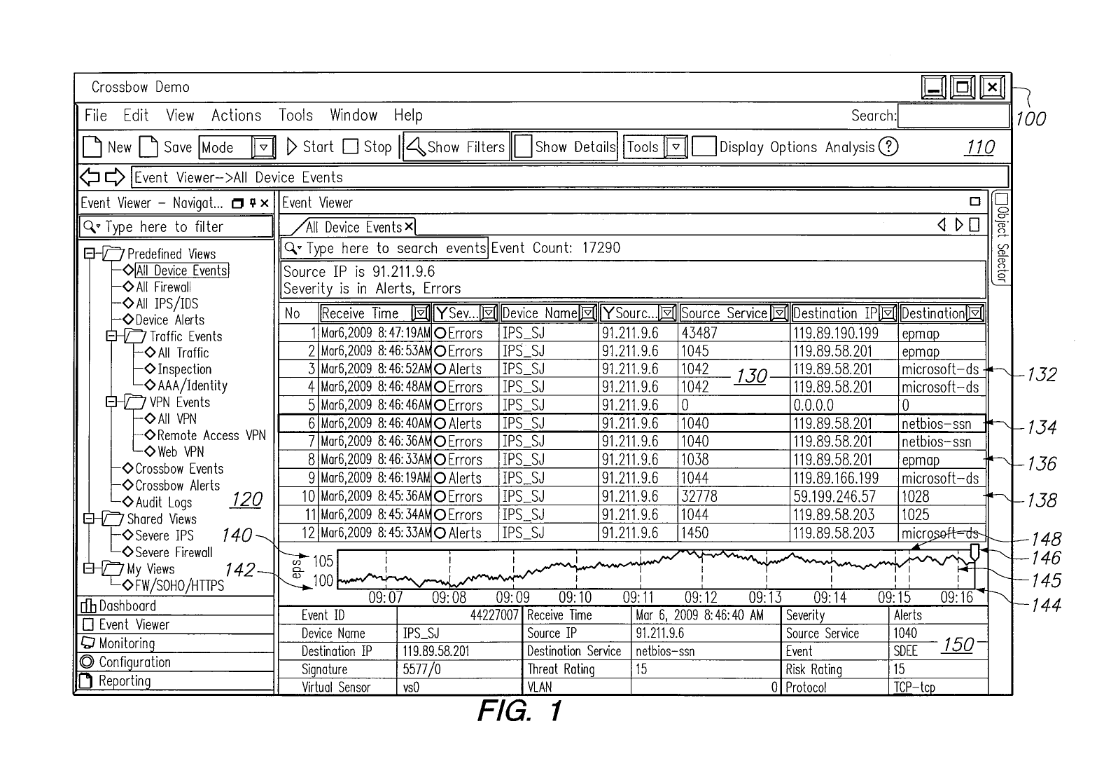

FIG. 1 illustrates an example computer screen display 100 comprising a toolbar 110, view navigator 120, event table 130, event graph 140, and event details region 150. In an embodiment, toolbar 110 features graphical user interface (GUI) widgets such as buttons which when selected activate functions such as saving an event view, exiting the display, loading event files, and changing views.

In an embodiment, view navigator 120 comprises a hierarchical tree listing named groups of events that are accessible for viewing in the event table 130, event graph 140, or event details region 150. In an embodiment, view navigator 120 allows a user to navigate through several different views of different kinds of events. For example, views defined in the view navigator 120 may encompass all events, all events associated with firewalls, all events relating to traffic, all events relating to virtual private network (VPN) processing, or user-defined groups of events. In one embodiment, the view navigator 120 allows the user to select which network or part of the network to monitor. In an embodiment, the view navigator 120 contains filter criteria that the user can use to remove certain network events from the event table 130.

In an embodiment, event table 130 comprises a listing of multiple individual events 132, 134, 136, 138, etc., that occurred at or were emitted by one or more network infrastructure elements and that match all of the filter criteria and that are within a time window represented by a loaded event indicator area 145 having at one endpoint a time slider 146 as discussed further below. As an example, FIG. 1 shows a list of events including four events comprising an alert 132, error 134, alert 136, and error 138.

In an embodiment, the user can select a particular event to receive more information about the event in the event details box 150. For example, in the figure, the user has selected error 134, which occurred at 09:08:12. In response to the selection, the time of the event, the descriptive term “error,” and additional information about the event are displayed in the event details box 150.

The event graph 140 provides a visual representation of the number of network events occurring within a particular sub range of time. An event database or repository stores all events that have been received by a network management system (NMS) or a particular router; the difference between the earliest such event and the latest event represents a range of time for all the events. However, typically all events cannot be displayed concurrently in screen display 100. Therefore, event graph 140 represents events that occurred between a particular sub range of time corresponding to or defined by a result of processing a query or view against all events in the database. In FIG. 1, the sub range is approximately 10 minutes of time between 09:07 and 09:16. A start time 142 and an end time 144 for the sub range may be selected using stored default values, or from user input specifying a query to the database or a view of the database.

Thus a horizontal axis of the event graph represents time and a vertical axis represents a magnitude of events, expressed in events per second (EPS) or other unit of time. In the example of FIG. 1, the range of the vertical axis is about 95 to 110 EPS. However, in other embodiments any other range may be used. In an embodiment, a computer that generates the display of FIG. 1 can automatically adjust the range of the vertical axis of event graph 140 dynamically depending on an actual range in EPS represented in a set of events of interest.

In an embodiment, event graph 140 further comprises a loaded event indicator area 145 delimited by a start time 148 and an end time 144. A graphical icon termed a time slider 146 is positioned at the end time 144. In the example of FIG. 1, end time 144 of the loaded event indicator area 145 and a position of the time slider 146 are the same, but movement of the time slider in response to user input may cause the end time of the loaded event indicator area to be different than a position of the time slider. For example, with rapid movement of a pointing device such as a mouse or trackball, a user may be able to slide the time slider to a new position faster than the system can load a new set of records and re-display the loaded event indicator area 145, due to network latency or storage device latency.

The start time 148 and end time 144 for the loaded event indicator area 145 may be determined using several mechanisms. In an embodiment, when the screen display 100 is first displayed, the start time 148 is set equal to the start time 142 of the event graph 140, and the time slider 146 is positioned at a specified difference from the start time; thus the loaded event indicator area 145 has a default width.

Alternatively, a start time and end time for the loaded event indicator area 145 may be obtained from user input through a configuration panel, popup menu, or other data input mechanism. The start time may be offset by a fixed number of records from a user-selected end time as indicated by a position of the time slider 146. For example, an embodiment may be implemented based on the premise that users typically want to review more recent events, so that loading event records starting from the current position of the time slider 146 and working backwards may be desirable.

In an embodiment, loaded event indicator area 145 is displayed using shading, or a distinct color, or different brightness, or other display attributes that cause the area to appear superimposed over the event graph 140. The time slider 146 may comprise a graphical icon, arrow, line, or other graphical feature.

In an embodiment, event table 130 displays summary information only for all events that fall within the time window represented by loaded event indicator area 145. In an embodiment, user input representing sliding the time slider 146 causes a computer to update event table 130 with different events that fall within the new position of the loaded event indicator area 145 after sliding and determining a new set of records within the loaded event indicator area.

2.2 Computer System Example

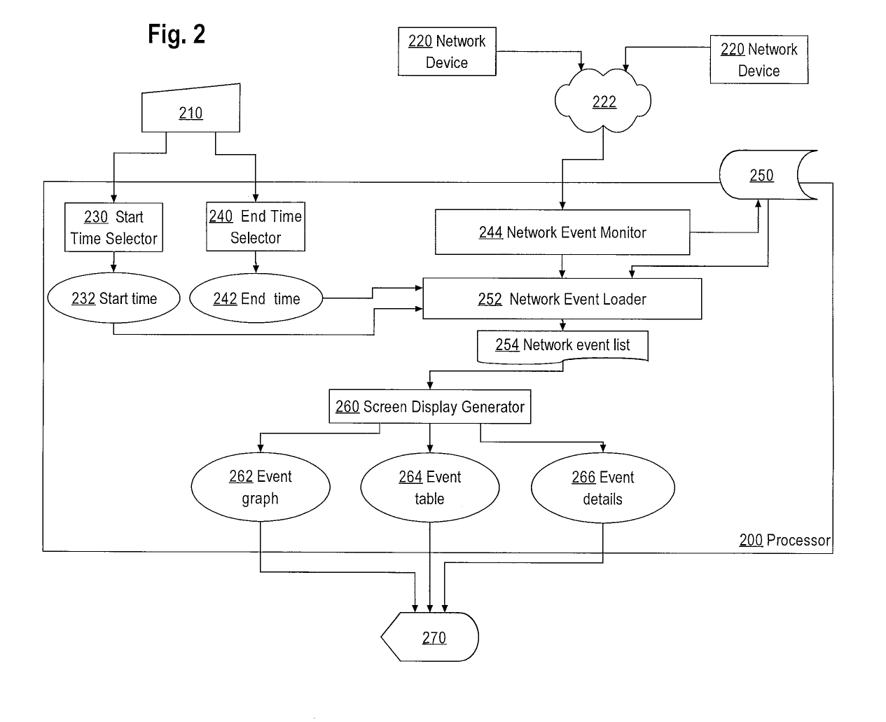

FIG. 2 illustrates a processor 200 configured to implement an embodiment of historical network event viewing. In an embodiment, processor 200 is coupled to an input device 210, a network 222, storage unit 250, and a display device 270. Input device 210 may comprise a keyboard, pointing device such as a mouse or trackball, and/or keypad. Display device 270 may comprise a video monitor. Storage unit 250 may comprise volatile or non-volatile memory or mass storage coupled to processor 200 or accessible to the processor indirectly via a network.

In an embodiment, processor 200 is implemented as a server computer coupled to a separate client computer that includes the input device 210 and the display device 270. Alternatively, the processor 200 may represent a complete computer, such as a network management system or station, having the input device 210 and display device 270 directly coupled.

In an embodiment, processor 200 is coupled to one or more networks or internetworks 222 that comprise network devices 220, which periodically generate events.

In an embodiment, processor 200 comprises a start time selector 230 and end time selector 240 coupled to the input device 210, which are configured to output a start time 232 and an end time 242 respectively as further described. A network event monitor 244 is coupled to networks 222 through an appropriate interface and to storage unit 250. A network event loader 252 is coupled to network event monitor 244 and storage unit 250, and receives start time 232 and end time 242 to result in generating a network event list 254 as further described. Processor 200 further includes a screen display generator 260 configured to receive network event list 254 and other data and to generate an event graph 262, event table 264, and event details 266 for output to display device 270, as further described.

In operation, start time selector 230 interacts with a user operating input device 210 and to result in selecting or determining a start time 232 for a sub range of events. In an embodiment, a specified number of records earlier than the start time 232 is determined, to result in selecting or determining the end time 242 for the sub range. The user interaction for the start time may comprise user input representing sliding the time slider 146 of FIG. 1.

Network event monitor 244 periodically receives events through network 222 from the network devices 220 and stores event records in storage unit 250. The network event loader 252 receives start time 232 and end time 242, and loads or obtains all network events in storage unit 250 that occurred between the start time and the end time, resulting in creating and transiently storing the network event list 254. In one approach, the network event loader 252 receives the start time 232 only and loads a specified number of records that occurred earlier than the start time; thus the end time 242 is implicit based on the last loaded record. Network event list 254 represents any form of data storage that can organize a group of network events and in various embodiments an array, hash table, or other mechanisms may be used.

The screen display generator 260 receives the network event list 254 and concurrently generates an event graph 262, an event table 264, and event details 266, which are provided to display device 270. In an embodiment, the event graph 262 displays a graph of counts of network events including those within the start time and end time; event table 264 lists summary information about the events within the start time and end time; and event details 266 comprises detailed data about a particular selected event. In an embodiment, a screen display that is provided to the display device 270 includes all of the event graph 262, event table 264, and event details 266 in association with one another.

2.3 Method of Network Event Viewing

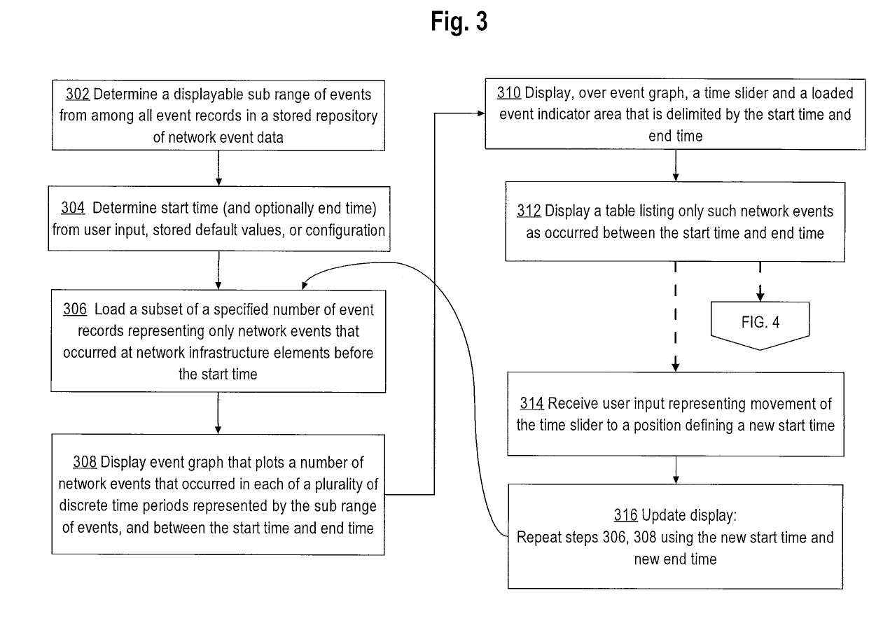

FIG. 3 illustrates a method of historical network event viewing.

In step 302, a displayable sub range of events is determined from among all event records in a stored repository of network event data. For example, storage unit 250 of FIG. 2 stores all event records for network event data. A displayable sub range of events may comprise a subset of all event records in storage unit 250 that satisfy a user-specified query or a selected view, and can be represented in the event graph 140 of FIG. 1.

In step 304, a start time and end time are determined based upon user input, stored default values, or configuration data. In one approach, user input is received only for the start time, which may be the current time, and the end time is determined automatically based on subtracting a specified offset time. In an embodiment, the start time and end time are within the displayable sub range, and represent endpoints of a further subset of events. In an embodiment, the time slider 146 indicates the start time, and the start time and end time delimit or define the loaded event indicator area 145 over the event graph 140. Alternatively, the user could type the start time and end time into a text box or select them from a drop down menu or combo box.

In step 306, the method loads a subset of event records representing only network events that occurred at network elements between the start time and the end time. For example, the process loads, from storage unit 250, and receives a specified number of records representing the network events taking place before the start time.

In step 308, the method causes displaying an event graph on a display device. The event graph plots a quantity, magnitude or number of network events that occurred in each of a plurality of discrete time periods represented by the sub range of events. The event graph also includes events that occurred between the start time and the end time. In an embodiment, the event graph is labeled with increments of time on one axis, and a number of events per unit time on the other axis.

In step 310, the process causes displaying, over the event graph, a time slider and a loaded event indicator area that is delimited by the start time and end time. The end time for the loaded event indicator area may be determined automatically based on a fixed offset from the start time indicated by the time slider, or using stored default values. In step 312, the processes causes displaying an event table including only such network events as occurred between the start time and the end time. At this point in the process, the display includes the event graph, the time slider, the loaded event indicator area and the event table shown concurrently or in association with one another.

At some point thereafter, in step 314, user input is received representing the movement of the time slider to a position defining a new start time. In response, in step 316 the process updates the display by repeating steps 306, 308 using the new start time.

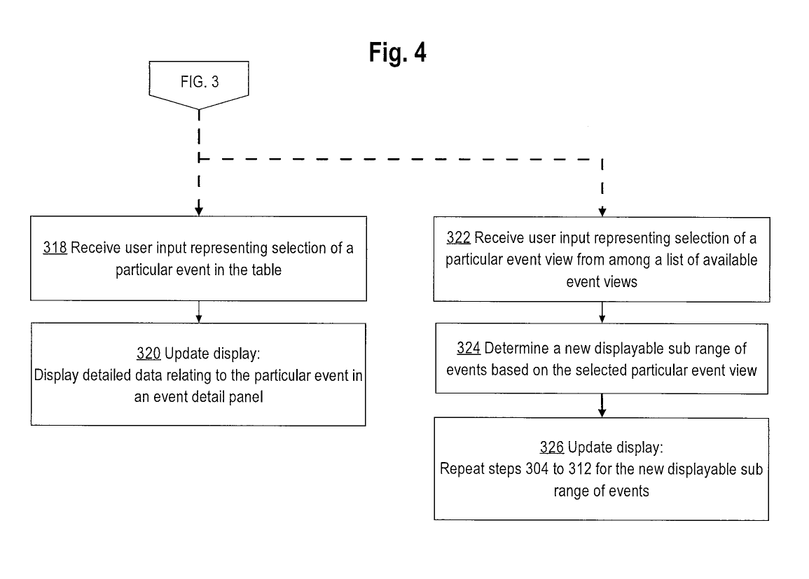

Referring now to FIG. 4, at step 318, at any time after step 312, user input may be received representing selecting a particular event from among all events shown in the event table. In response, at step 320 the process causes updating the display by displaying detailed information about the event in an event detail panel on the display device. Responsive processing may include issuing further queries to the storage unit 250, if necessary, to obtain detailed event information.

Additionally or alternatively, at step 322, the process may receive user input representing a selection of a different particular event view from among a list of available event views. For example, FIG. 1 may be understood to show that a user previously selected the “All Device Events” view in view navigator 120, and then performed the process described above for FIG. 3 and FIG. 4. An initial view may be selected, for example, in connection with step 302 or step 304. At any time, the process may receive user input selecting a different view that is listed in the view navigator 120. In response, at step 324, the process determines a new displayable sub range of events based on the selected particular event view. For example, step 324 may involve forming and sending a query to a database in storage unit 250 and receiving a new set of event records in return. In step 326, the process updates the display by repeating steps 304 to 312 for the new displayable sub range of events.

Embodiments have been described in which the event graph comprises a start point and an end point, and the start point and end point respectively represent an earliest time and a latest time at which network events matching results of a query to a stored repository of event data occurred. In an embodiment, the entire range of the graph represents a time window of interest for the user. The time window of interest may represent, for a broad investigation, the entire range of time that has events. Alternatively, for a forensic investigation the time window of interest may be a range of time around an event, such as the surrounding 24 hours, or the surrounding week depending on the circumstances. The amount of surrounding time represented in the event graph may be user configured. The bounds of the range may be set using default values, and after launching a given view the user may modify the bounds.

In some embodiments, the range that actually contains matching events may be difficult to determine without running a comprehensive query, requiring extensive processing time. The lazy loading approach described herein permits the system to represent a range in which events may match the query bounded by the range of data in the system and optionally additionally bounded by the user to match an area of user interest. This approach adds utility to the event graph by permitting the user to focus on a narrower time range that contains, for example, a peak area of events.

3.0 Historical Network Event Viewing—Detailed Example

3.1 View Management

In an embodiment, the event views identified in view navigator 120 comprise datasets that a user can manage. In an embodiment, a view comprises query parameters, column sets, and display options. Query parameters comprise a set of filters which map to a set of event types, a time interval (for historic viewing), a device list or device group, and any number of additional criteria on any of the event attributes. A column set refers to a view containing a list of columns that are meaningful in the context of the view. Display options include column settings (show/hide, column width, column sequence) and sort options (sorting column, sort order, ascending/descending).

In an embodiment, a user can select predefined views and custom views. Predefined views are stored datasets defining views that represent a broad categorization of event types that are commonly used. A predefined view has predefined query parameters and column set that cannot be changed by a user. In an embodiment, there are three types of predefined event views: device event views, system event views, and firewall event views. Each of the predefined views is associated with a set of event types or event category or other predefined filtering criteria. Each view is preconfigured with a set of displayed columns. Detailed mappings from view to event type, event category, filters, and column attributes are defined in metadata, and can be modified.

Custom Views are created from a base predefined view and may be user-customized by changing query parameters or display options. User defined view definitions may be stored on a configuration server coupled to processor 200.

In an embodiment, navigation of views is provided using a tree display as represented by view navigator 120 of FIG. 1 with highest level branches comprising view categories, for example, “Predefined”, “Shared” or “My View”. The “Predefined Views” branch contains all predefined view structures. The “Shared Views” and “My Views” branches contain user views and any user created folder structures. Under “Shared Views”, all shared views in the system are listed, while “My View” contains only private views created by the current user. In an embodiment, views are launched by double clicking on the view name in the navigation tree. The user can change the viewing mode to a time period in which she is interested by selecting a start and end time.

In an embodiment, multiple views can be opened at the same time. These multiple views are displayed as separate tabs or windows in the workspace area of the user interface. In an embodiment, every time a view is launched from the navigation tree, a new tab is opened by default. If the same view is already open in a tab, a new instance of the view is opened in a new tab and named with a suffix indicating the number of occurrences of the view. In an embodiment, an option is provided on the context menu to open the view in the currently active tab.

3.2 Event Table

In an embodiment, the event table in the event viewer of FIG. 1 displays events corresponding to the selected view. In an embodiment, filters on the query of the view are evaluated at a server computer, and sorting is performed at a client computer. By default, the table lists the event in backward sequence of event received time, therefore showing most recent event on top. However, other default sequences are possible and the user can change the sequence. Various embodiments support historical event viewing and real-time event viewing, as now described.

3.2.1 Historical Event Viewing

Historical event viewing involves running a query to find records of stored events matching user specified filters for a time window in the past. Depending on the length of the time interval and the events per second rate during the interval, a large amount of event data across multiple partitions might need to be scanned from the event store, transferred, processed, and displayed in the event table. When a client-server architecture is used, the scan, transfer and processing operations may result in delays in displaying results. In an embodiment, lazy loading, paging, data encoding, and data compression techniques can improve responsiveness.

In lazy loading, data is retrieved in batches and presented incrementally as each batch of data becomes available. In an embodiment, once a historic view is launched, a query is initialized on the server. The server starts scanning for matching events from the store using any applicable index and query hits are put into a buffer. The client fetches events from the server continuously specifying the maximum number of events (i.e., batch size) to be returned. The server returns query hits up to the specified batch size with a set of query status meta information. The query hits are added to the end of the table while meta data such as number of events scanned, to be scanned, and time range scanned, are used to calculate the thumb size on the vertical scroll bar of the viewer, size of shaded area and time marking on the EPS slider, and to update the progress bar/clock. The fetches continues until either the page is filled, or a predetermined scan time limit is reached on the server. If the scan time limit is reached and a page is not filled, the server sends an exception back to the client so a dialog can be displayed to the user. If scanning is to continue, the client will continue to fetch hits from the server.

The batch size for each retrieval is programmatically controlled such that the first fetch quickly returns a small number of events, (e.g., 100 events) enough to fill the visible rows of the table, and larger batch size for subsequent fetches to minimize the number of fetches to load a page. This provides an immediate response when the view is launched while more data are being lazy loaded.

In an embodiment, lazy loading is performed for each page of event data. The time slider 146 provides a visual and progressive presentation of page coverage over time as well as a paging control for the user. Paging is a client side control that allows the user to manage a large amount of data by viewing the data one page at a time. Lazy loading and paging allow the user to query transparently through all stored partitions in the collector.

In one embodiment, the client specifies a maximum number of events to be retrieved, which can be the same as the client side page size. Therefore, each time the user pages through data, a new historic query is initialized. Client logic can carry expanded filter criteria from page to page to save the time involved on the server side to recalculate the device list.

The total time interval and granularity on the slider 146 is dynamically calculated so that any time interval length can be shown in the workspace pane. Therefore the time granularity may vary from query to query depending on the queried time interval. In an embodiment, event graph 140 does not have to be bounded by the initial query time filter. In the unbounded mode, the event graph 140 shows the entire page time frame in a comfortable percentage of the event table width with room on either side to provide space to control paging. This can be used to provide an alternate way for changing the time filter on the query if needed.

To plot total and high severity events in the event graph 140, the client specifies the number of data points to be graphed over a time interval. The server calculates and aggregates the data points from the data store as necessary.

Compression or data encoding reduces the size of the data that is transferred between the server and the client, reducing transmission time, hence increasing user response time. Compression may be achieved primarily based on using the same encoded storage format to transfer events from the server to the client. In one embodiment, event data are encoded in the event store. Although a query manager may need to decode events to perform filtering on the server, the original encoded events are transmitted to the client. Upon receipt at the client, each event is decoded directly into UI objects for rendering. Additional compression may be applied to further compact the returned data from the server just before transmission.

As lazy loading of data occurs, the number of events displayed in the table grows. The time granularity on the time slider 146 may be adjusted automatically under computer control to allow all or an appropriate proportion of the user's requested time period to fit in the allocated screen space.

In an embodiment, the event graph includes two event magnitude scales. A first event magnitude scale represents total EPS for an event collector. A second event magnitude scale represents EPS of high priority events. Therefore, a user can visually correlate event volume relative to the queried time period, highlighting spikes where user can zoom in, if necessary.

In an embodiment, in toolbar 110, the event viewer of FIG. 1 provides user controls that affect data loading including:

Stop: Halts query processing on the server.

Start: Event buffers at both the client and the server are cleared, and the query is run again. If the time filter on the query was a relative time interval such as “last 10 minutes”, the query is run using the new current time.

Filtering: Filtering is performed on the server. If the query criteria are changed while the query is running, the query has to be rerun. All the data retrieved previously is removed and refreshed with data from the new query. Unless explicitly changed, the absolute time interval used in the query stays the same. For example, a “last 10 minutes” query that was resolved at 10:30 AM to 10:20-10:30 AM does not change when the filter is changed.

Sorting: Sorting is performed on data available on the client, and lazily loaded data are sorted on the fly and added to the table based on the sort sequence. Since the time sequence of events in the event store is not guaranteed, a default sort is applied on event received time on the client. This default sorting can be overridden by any custom sort setting associated with the displayed view.

Paging: Paging controls are provided on the time slider 146 to allow exact next and previous paging as well as time scrolling. When the time slider is moved, the exact time can be provided in a tool tip based on the location of the control. Changing the paging control causes the table to be cleared and re-loaded; similarly, in an embodiment the highlighted area on the time slider disappears and starts growing again to the left from the new end time.

Long running query: If a query filter is hard to satisfy over the specified time frame, the server may keep scanning and producing few or zero records. In an embodiment, a predefined timeout period is defined on the server; if the timeout value is reached and the event table is not filled, then the user is presented with a dialog asking if the query should continue to run.

3.2.2 Real Time Event Viewing

Real time event viewing provides a scrolling view of filtered events as they are received in an event collector coupled to processor 200. In an embodiment, processor 200 can achieve a reasonable scrolling rate so that all events of interest are displayed through the viewer. In an embodiment, the real time viewer is implemented through a circular real-time buffer of a predetermined size, for example 50,000 events, which is filled from the collector's shared buffer and keeps the most recent query hits. As the real time buffer fills to capacity, the oldest events are removed from the buffer to make room for new events. Thus, the real time viewer acts as a window into the real time buffer on the server, and scrolling the real time viewer is equivalent to moving the window of visibility up and down the real time buffer.

At a predetermined fixed time interval, the real time viewer polls the server for new data from the real time buffer at the vertical scroll position. When filtered event rate is equal or lower to the polling rate, the real time viewer shows a reasonable rate of events scrolling down the real time viewer. At a high rate however, the visible rows of the real time viewer may be completely refreshed with new events, potentially skipping events between refreshes. A warning can be displayed when event rates are too high for proper viewing.

In one embodiment, the client computer does not cache the events on the real time viewer. While the viewer is running, sorting is disabled. In an embodiment, “Stop” and “Start” controls are available on the real time viewer for user to manage the viewer as follows:

Stop: Scrolling is stopped on the viewer to allow the user to select an event for further investigation. The stop action disconnects the real time reader in the backend from the collector shared buffer. The content of the buffer is lazily loaded into the client, allowing user to perform functions as in the historic viewing mode. At this point, the user is seamlessly switched into historic viewing mode with the same query filters and a time interval spanning the entire real-time viewing time window. The time slider is available to allow user to page into events earlier than the events preloaded from the real time reader.

Start: The starting control is only enabled when the viewer has been stopped previously. When “start” is invoked, the user is switched back into real time viewing mode. A new real time query is initialized with the current filter criteria and a new real time buffer is started in on the server. An option can be offered to the user to either save or leave open the previous result set and to start the new real time session in a new viewer tab.

Filtering: Since real time viewing is not based on a fixed time interval, in one embodiment, any filtering change while the viewer is running is applied only to events received on or after the time of the filter change. Events in the server buffer prior to the filter change time are preserved. Thus, if the user scrolls back in time, old unfiltered events can still be displayed.

Sorting: Since sorting is performed on data available on the client and only the visible rows are available in the client, sorting does not make sense on the real-time viewer and is disabled. It can be enabled when real-time viewing is stopped and switched to historic viewing mode.

In one embodiment, a circular real-time buffer of a predetermined size in system properties (e.g., 50,000 events) is configured on a monitoring server 660 as further described herein, and is sourced directly from an event collector's shared buffer and keeps the most recent query hits. As the real time buffer fills to capacity, the oldest events are removed to make room for new events. At every refresh interval (e.g., 0.5 seconds), a client retrieval request specifies a start index in the backend buffer and a fetch size of just above the visible number of rows on the viewer. The server returns the result set with meta information pertaining to the real time query. The events in the result set are added to the top of the event table 130, while meta information such as the number of events in the real time buffer are used to determine the thumb size in the vertical scroll bar of the viewer.

Additionally, an average EPS since the last fetch is also returned in the meta information. The EPS returned from the server can be used to determine if the real time viewer is keeping up with the backend and whether the warning should be displayed. An exact process to be used to determine if rate is too high for proper real-time viewing can be tuned and determined.

When the user stops the real time viewer, the viewing mode is changed automatically to historic. The client terminates the real time query and uses the start and end time of the original real-time viewing as timeline on the event graph 140. However, the graph may not be available immediately since there may be some time delay before all events in the real time reader's buffer are persisted into the store. The graphing logic can keep retrying and get data points in batches starting from the start time of the time frame

3.2.3 Event Column Display

In an embodiment, the initial set of displayed columns in the event table is determined based on the column set in the selected view and any user customization. Additional columns are dynamically added based on available fields in the result set to the end of the column list. If the user makes column setting changes and saves the view, the dynamically added columns are saved with the view. In an embodiment, column widths are self adjusted by default to show the heading in full. Column widths, sequence, and visibility are user customizable. In an embodiment, column data are rendered based on the corresponding event field type by default.

In an embodiment, controls are available from any column header in the event table as follows:

Sorting: When the user clicks on a header, the computer sorts events in the table by that column. When the user clicks a second time, the computer reverses the sort sequence. When the user clicks a third time, the computer removes the sort. When the user control clicks, the computer adds additional sort columns.

Filtering: A drop down menu provides type-specific filtering options. This menu may have a list of customized values, a list of possible values in the table, or a customized dialog, for example, a device selector. The menu serves as a shortcut to change the filter and apply immediately. Cumulative filter change is supported through a control in the filter panel. The “Custom” option in the filtering drop down opens a custom selector for each column. Specialized selectors are provided for complex fields.

3.3 Event Details

In one embodiment, event details panel 150 comprises a summary tab that shows data obtained from all non-null fields of an event object retrieved from the data storage unit 250 and corresponding to a selected event. Data is displayed in the form of label-value pairs within the summary tag and the order of the fields may be the same as the order in a byte array within the event object. In one embodiment, related fields may be grouped together using available meta information in the field dictionary, such as field type or naming convention. In one embodiment, an event notes tab is provided and can receive user input representing event annotations. With the event notes tab, a user can create and store an event status (New, Assigned, Acknowledged, Closed, etc.) and add an optional note to the event.

3.4 Example System Architecture and Data Structures

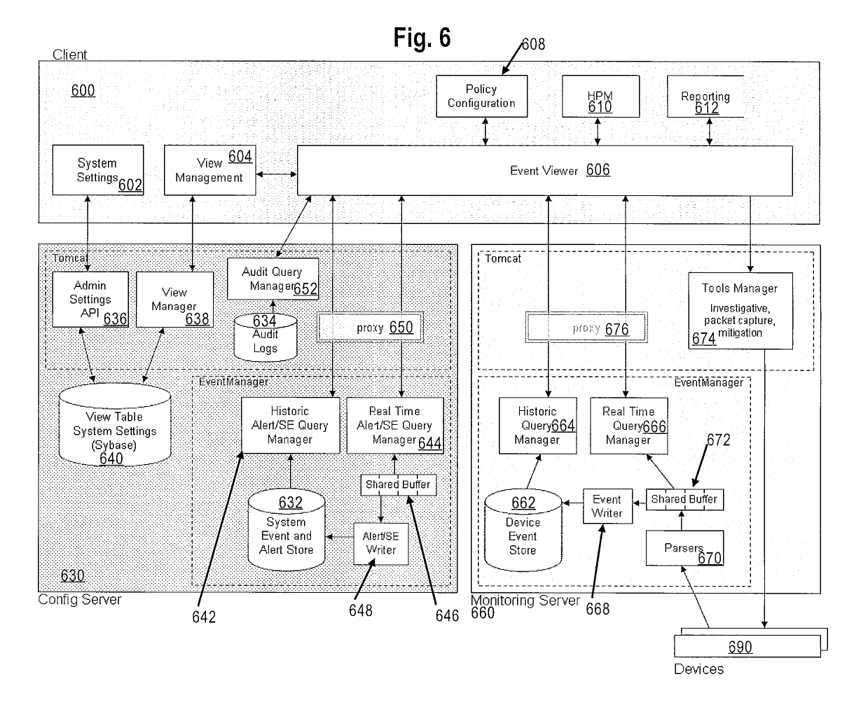

FIG. 6 illustrates an example computer system of an embodiment. In an embodiment, a data processing system generally comprises a client 600, a configuration server 630, a monitoring server 660, and one or more internetworking devices 690.

The client 600 has system settings logic 602, view management logic 604, event viewer logic 606, policy configuration logic 608, HPM logic 610, and reporting logic 612. The system settings logic 602 is configured to enable a user to change system-wide parameter values. The view management logic 604 is configured to receive requests to select different views and to form view requests for the configuration server 630. The event viewer logic 606 is configured to generate a GUI of the type seen in FIG. 1 and to perform the functions described herein for FIG. 3, FIG. 4. The policy configuration logic 608, HPM logic 610, and reporting logic 612 represent external policy, monitoring, and reporting systems that can interface to the event viewer 606 or access event viewing functions through a cross-launching capability. For example, when the user is interacting with a reporting application, a cross-launching function may be provided with which the user can access certain event viewing functions from within the reporting application.

The configuration server 630 has a system event and alert store 632, audit logs 634, administrative settings API 636, a view manager 638, a view table system settings database 640, a historic alert/SE query manager 642, a real time alert/SE query manager 644, a shared buffer 646, an alert/SE writer 648, a proxy 650, and an audit query manager 652. In an embodiment, the system event and alert store 632 provides a non-volatile repository for storing events and alerts that are received from applications, systems, or other logical units other than internetworking devices 690, or that are formed based on correlations performed on network events.

The audit logs 634 provide non-volatile storage of log records for user changes to the system, which are received at audit query manager 652. For example, user changes to configuration or policy may require review or auditing, and can be logged in audit logs 634. The administrative settings API 636 exposes programmatic functions that systems settings logic 602 can call to perform system parameter changes. The a view manager 638 is configured to determine filter criteria for views, issue requests for events to repositories, and store view settings in the view table system settings database 640. The historic alert/SE query manager 642 is configured to manage issuing and processing queries for historic event data directed to the system event and alert store 632. The real time alert/SE query manager 644 is configured to manage issuing and processing queries for real time event data directed to the buffer 646, which may be implemented using shared memory with an event collector that directly receives events from devices 690, such as shared buffer 672. The alert/SE writer 648 is configured to write alerts in store 632 based on correlating events or after receiving system events or alerts from other sources. Event viewer 606 can direct queries to managers 642, 644 directly or through a proxy 650.

The monitoring server 660 has a device event store 662, a historic query manager 664, a real time query manager 666, an event writer 668, parsers 670, a shared buffer 672, a tools manager 674 providing investigative, packet capture, and mitigation functionality, and a proxy 676. In an embodiment, device event store 662 provides a non-volatile repository for event messages that are received indirectly from internetworking devices 690. The historic query manager 664 is configured to form queries directed to the store 662 and requesting stored historical event records. The real time query manager 666 is configured to form queries directed to the shared buffer 672 to obtain records of event messages received in real time from other sources. Parsers 670 receive events directly from devices 690 and parse the event messages to identify field values corresponding to the schema or record format that is used in store 662. The parsers 670 then provide the parsed event data to shared buffer 672 and to the event writer 668 for writing into the store 662. The tools manager 674 is configured to provide user access to processes providing investigative, packet capture, and mitigation functionality. Event viewer 606 can issue queries to the store 662 directly or through proxy 676.

In an embodiment, the configuration server and monitoring server 660 comprise three separate event stores. Device event store 662 is on the monitoring server, while audit log store 634 and system event and alert store 632 are on the configuration server. Depending on the view type being launched, the corresponding query manager can be invoked to service the query. All view management and system settings transactions are handled on the configuration server and data are persisted in a database such as view table system settings database 640. Except for audit logs, all event queries are forwarded to the event manager process. Investigative tools may be run on either the monitoring server or a monitoring device.

In operation, view management initialization logic 604 calls the view manager 638 to initialize views to be displayed on the view navigation tree for current user. These views include the set of predefined views, any user customization on the predefined views, all shared views, and all user private views. The event viewer initialization 606 reads event viewer metadata to register event viewer specific GUI objects, filters, or other elements. Any global display option relevant to event viewer is read using the admin settings API 636. All settings pertaining to the event viewer are read from and cached in the View Table System Settings 640.

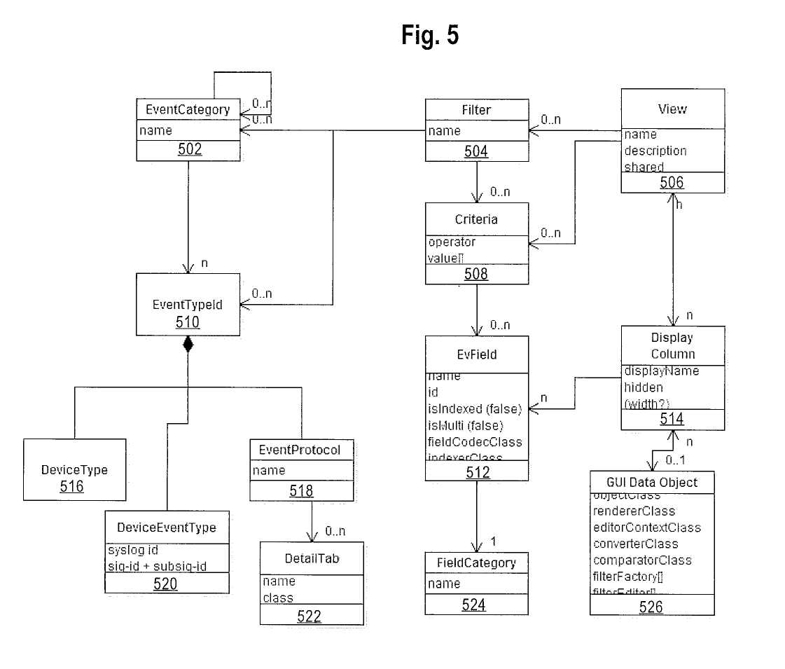

In an embodiment, the event viewer is designed to be generic and easily extensible to display different types of event-like objects. Event objects and display mechanisms are designed to be data driven. FIG. 5 illustrates example programmatic objects and relationships that may be used in an embodiment, including an object schema for viewer definition files, and showing relationships to event model field definition. In an embodiment, the lowest level event categories, for example DeviceType 716, EventProtocol 718, DeviceEventType 720, and DetailTab 722, are mapped to EventTypeId 710 and are defined in event protocol specific catalogs, such as syslog catalog, NSDB for IPS events, NG catalog, system events, alerts, audit. The higher level event categories 702 are defined in separate metadata.

On the client side, four catalogs are provided. Predefined View 706 Definition: A view consists of set of “DisplayColumn”, a set of “Filter” or a set of “Criteria”. Criteria are equivalent to inline filters defined within the view definition metadata. For each column in a view, if there is no special rendering requirement for the field (such as adding an icon, performing a lookup, etc.) then it just refers to the EvField 712 name itself. If the column needs any special handling or is either a derived or compound field, then an entry can be defined in the Column Definition file. A field that directly refers to an EvField must not be an “Extended” field (e.g., IP trigger packet).

Filter 704 Definition: A filter is a set of frequently used filter criteria that are named and can be reused by different components of an embodiment of the invention. A filter consists of combination of EventCategories 702, EventTypeIds 710, and other criteria based on event fields. In addition to using filters for querying and cross-launching into event viewers on the client side, filters can be attached to event streams on the server. Filter definitions are not user configurable and are not exposed on the user interface.

Display Column 714 Definition: The display column 714 field map the display column to GUI data class. Column made up of multiple fields, derived fields, or just fields that require special handling should be defined here. Each Column in this definition can be reused in different views. Each column here is handled by a specialized user interface (UI) object, defined in the user interface object definition file. A user interface object can be reused by multiple columns.

GUI Data Object 726 Definition: The GUI Data Object 726 file defines the GUI data class used to render a cell, and any additional special handler class as needed. These classes are registered during client startup. The classes that need to be defined by the GUI Data Object 726 include: Object converter, Object converter context, Renderer, Editor, Editor Context, Filter editor, Filter factories, and Comparator.

4.0 Implementation Mechanisms—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

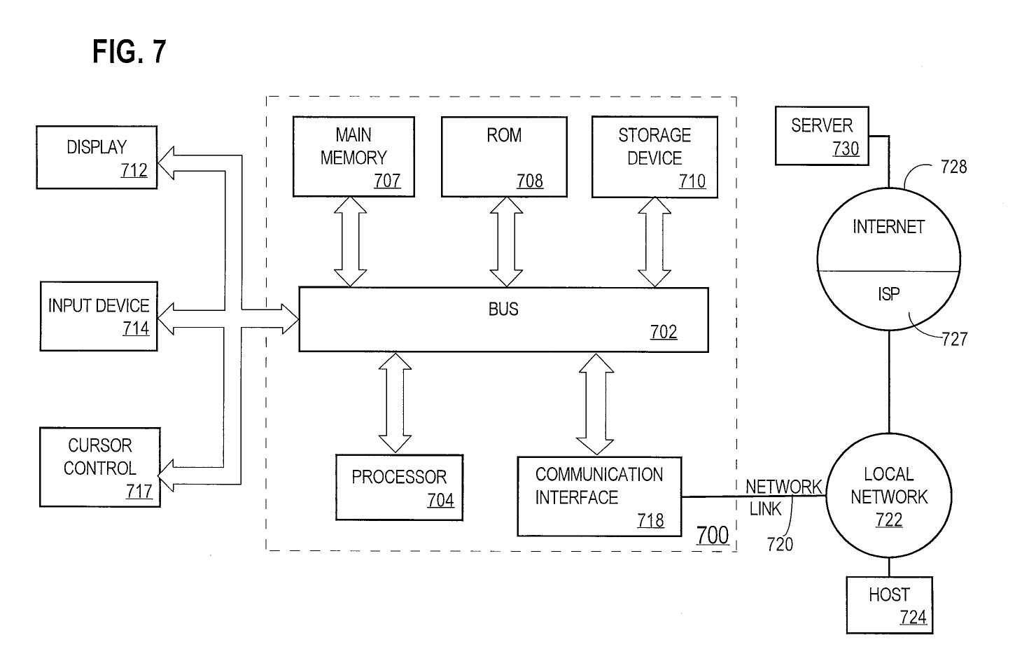

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

5.0 Extensions and Alternatives

In the foregoing specification, embodiments of the invention have been described with reference to numerous specific details that may vary from implementation to implementation. The specification and drawings are, accordingly, to be regarded in an illustrative rather than a restrictive sense.

What is claimed is:

1. A computer-implemented method, comprising:
determining a displayable sub range of events from among event records in a stored repository of network event data;
determining a start time;
in response to determining the start time, loading from the repository, a subset of a specified number of event records representing only network events that occurred at one or more network infrastructure elements before the start time;
graphically displaying, in a first portion of a screen display on a display unit, an event graph that plots a number of network events that occurred in each of a plurality of discrete time periods represented by the sub range of events, and between the start time and an end time;
graphically displaying, over the event graph, a time slider and a loaded event indicator area that is delimited by the start time and the end time;
displaying, in a second portion of the screen display, a table listing only such network events as occurred between the start time and end time as indicated by the loaded event indicator area;
wherein the steps are performed by one or more computing devices.

2. The method of claim 1, further comprising receiving user input selecting a particular network event from within the table; displaying, in a third portion of the screen, an event details listing that details of the particular event.

3. The method of claim 1, wherein the user input comprises signals representing a user sliding the time slider on the event graph.

4. The method of claim 1, further comprising receiving user input specifying a sorting criterion for the network events shown in the table; in response to receiving the user input, sorting and re-displaying the table based on the sorting criterion.

5. The method of claim 1, further comprising displaying the loaded event indicator area in a different color intensity than the event graph.

6. The method of claim 1, further comprising receiving user input representing sliding the time slider to a position earlier or later than all time values then currently represented in the event graph; in response to the user input, loading from the stored repository of network event data, a second subset of the specified number of event records representing only network events that occurred at the one or more network infrastructure elements earlier than a new start time represented by the position of the time slider.

7. The method of claim 1, wherein the event graph comprises a start point and an end point, and wherein the start point and end point respectively represent an earliest time and a latest time at which network events matching results of a query to a stored repository of event data occurred.

8. A computer-readable data storage medium storing one or more sequences of instructions which when executed cause a computer to perform:
determining a displayable sub range of events from among event records in a stored repository of network event data;
determining a start time;
in response to determining the start time, loading from the repository, a subset of a specified number of event records representing only network events that occurred at one or more network infrastructure elements before the start time;
graphically displaying, in a first portion of a screen display on a display unit, an event graph that plots a number of network events that occurred in each of a plurality of discrete time periods represented by the sub range of events, and between the start time and an end time;
graphically displaying, over the event graph, a time slider and a loaded event indicator area that is delimited by the start time and the end time;
displaying, in a second portion of the screen display, a table listing only such network events as occurred between the start time and end time as indicated by the loaded event indicator area.

9. The computer-readable data storage medium of claim 8, further comprising instructions which when executed cause receiving user input selecting a particular network event from within the table; displaying, in a third portion of the screen, an event details listing that details of the particular event.

10. The computer-readable data storage medium of claim 8, wherein the user input comprises a user sliding the time slider on the event graph.

11. The computer-readable data storage medium of claim 8, further comprising instructions which when executed cause receiving user input specifying a sorting criterion for the network events shown in the table; in response to receiving the user input, sorting and re-displaying the table based on the sorting criterion.

12. The computer-readable data storage medium of claim 8, further comprising instructions which when executed cause displaying the loaded event indicator area in a different color intensity than the event graph.

13. The computer-readable data storage medium of claim 8, further comprising instructions which when executed cause receiving user input representing sliding the time slider to a position earlier or later than all time values then currently represented in the event graph; in response to the user input, loading from the stored repository of network event data, a second subset of the specified number of event records representing only network events that occurred at the one or more network infrastructure elements earlier than a new start time represented by the position of the time slider.

14. The computer-readable data storage medium of claim 8, wherein the event graph comprises a start point and an end point, and wherein the start point and end point respectively represent an earliest time and a latest time at which network events matching results of a query to a stored repository of event data occurred.

15. An apparatus, comprising:
one or more processors;
a computer-readable data storage medium coupled to the one or more processors and storing one or more sequences of instructions which when executed cause a computer to perform:
determining a displayable sub range of events from among event records in a stored repository of network event data;
determining a start time;
in response to determining the start time, loading from the repository, a subset of a specified number of event records representing only network events that occurred at one or more network infrastructure elements before the start time;
graphically displaying, in a first portion of a screen display on a display unit, an event graph that plots a number of network events that occurred in each of a plurality of discrete time periods represented by the sub range of events, and between the start time and an end time;
graphically displaying, over the event graph, a time slider and loaded event indicator area that is delimited by the start time and the end time;
displaying, in a second portion of the screen display, a table listing only such network events as occurred between the start time and end time as indicated by the loaded event indicator area.

16. The apparatus of claim 15, further comprising instructions which when executed cause receiving user input selecting a particular network event from within the table; displaying, in a third portion of the screen, an event details listing that details of the particular event.

17. The apparatus of claim 15, wherein the user input comprises a user sliding the time slider on the event graph.

18. The apparatus of claim 15, further comprising instructions which when executed cause receiving user input specifying a sorting criterion for the network events shown in the table; in response to receiving the user input, sorting and re-displaying the table based on the sorting criterion.

19. The apparatus of claim 15, further comprising instructions which when executed cause displaying the loaded event indicator area in a different color intensity than the event graph.

20. The apparatus of claim 15, further comprising instructions which when executed cause receiving user input representing sliding the time slider to a position earlier or later than all time values then currently represented in the event graph; in response to the user input, loading from the stored repository of network event data, a second subset of the specified number of event records representing only network events that occurred at the one or more network infrastructure elements earlier than a new start time represented by the position of the time slider.
